(19) United States
(12) Patent Application Publication
(10) Pub. No.: US 2008/0285400 A1
(43) Pub. Date: Nov. 20, 2008

(54) Recording Apparatus and Recording Method

(75) Inventor: Willem Geurtzen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,490

(22) PCT Filed: Oct. 18, 2006
(86) PCT No.: PCT/IB2006/053843

§ 371 Date: Apr. 25, 2008

(30) Foreign Application Priority Data
Oct. 31, 2005 (EP) 05110179.8

(51) Int. Cl. G11B 5/09

(52) U.S. Cl. 369/47.5

(57) ABSTRACT

The present invention relates to a recording apparatus and a corresponding recording method for recording marks in an information layer (601) of a record carrier (60) by irradiating the information layer by means of a radiation beam, said information layer having a phase reversibly changeable between a first phase and a second phase, wherein a mark is written by a sequence of one or more write pulses, the number of write pulses of the sequence for writing a mark of length NT, T being the length of a reference clock, being determined by application of a predetermined write strategy. To combine the advantages of the known write strategies of the high speed DVD+RW and DVD-RW standards, a recording apparatus is proposed comprising: a radiation source (61) for providing the radiation beam (62), and a control unit (65) for controlling the power of the radiation beam according to a data pulse representing the mark to be written, to provide said sequences of write pulses for recording the marks, said control unit being operative for setting the following parameters: a trailing time (dT_{mpip,0}) of the last pulse of a sequence for writing a mark of length NT, in case N is an odd number, relative to the trailing edge of the last channel bit of the data pulse representing a shortest allowable mark, a trailing time dT_{mpip,e}) of the last pulse of a sequence for writing a mark of length NT, in case N is an even number, relative to the trailing edge of the last channel bit of the data pulse, and—a lead time (dT_{ip,e}) of the last pulse of a sequence for writing a mark of length NT, in case N is an even number, relative to the leading edge of the last channel bit of the data pulse.

The present invention relates to a recording apparatus and a corresponding recording method for recording marks in an information layer of a record carrier by irradiating the information layer by means of a radiation beam, said information layer having a phase reversibly changeable between a first phase and a second phase, wherein a mark is written by a sequence of one or more write pulses, the number of write pulses of the sequence for writing a mark of length NT, T being the length of a reference clock, being determined by application of a predetermined write strategy. Further, the present invention relates to a computer program for implementing the control steps of said recording method on a computer.

An information layer having a phase reversibly changeable between a first phase (e.g. a crystal phase) and a second phase (e.g. an amorphous phase) is generally known as a phase-change layer. Such a phase-change layer is often applied in optical record carriers of the rewritable type, such as for example BD-RE, CD-RW, DVD-RW, DVD+RW and DVD-RAM discs. A recording operation of optical signals is performed in such a manner that the recording material in the layer is changed in phase reversibly between an amorphous phase and a crystalline phase by changing the irradiation conditions of a radiation beam thereby to record the signals in the phase-change layer, while a playback operation of the recorded signals is performed by detecting differences in optical properties between the amorphous and crystalline phase of the phase-change layer thereby to reproduce the signals. Such a phase-change layer allows information to be recorded and erased by modulating the power of the radiation beam between a write power level, an erase power level and a bias power level.

Recording speed is the main performance factor in optical recording. For CD-RW, the basic standard is defined for the speed range 1×-4×; the high-speed CD-RW standard has a range from 4×-10×. In September 2002, version 1.0 of the latest Ultra-Speed CD-RW standard was released defining CD-RW discs for speeds up to 24×, including also reservations for 32× and higher speeds (Recordable Compact Disc Systems, Part III: CD-RW, Volume 3: Ultra-Speed, Version 1.0, September 2002). To achieve these recording speeds, use has to be made of a so-called 2T write strategy as defined in the Ultra-Speed CD-RW standard. Therein, basically one write pulse is used for every two clock cycles of a reference clock T. This is done to obtain sufficient cooling times and thereby to avoid recrystallization which is a problem especially with faster phase-change materials. A consequence of this 2T write strategy is that consecutive even and odd marks are written with the same number of write pulses, e.g. 3 pulses for a 6T and a 7T mark.

A method and a recording device for recording marks in an information layer of an optical record carrier using a 2T write strategy have also been described in European patent application 02 080 394.6 (PHNL 021391EPP). The described method and recording device solve the problem of how to record marks in an information layer when no write parameter settings specifically tuned for the record carrier to be recorded are available for use in the 2T write strategy or when the record carrier can not be identified. Preferred settings for the write parameters of a 2T write strategy are therefore proposed.

An essential point of the 2T write strategy is the choice of the write parameters that define the difference between even and odd marks. Even marks are defined in a straight forward way by a pulse-train with multi-pulse length Tₘₚ and cooling gap T_{c}. To create a length of (even mark +1) for the odd marks, the pulse-train is modified at three positions, an elongation of the one but last gap (Δ_{1g}), the last pulse (Δ₁ₚ) and the last cooling gap (Δ₂), wherein Δ_{1g}=Δ₁ₚ=Δ₁ according to the Ultra-Speed CD-RW standard. Furthermore, the shortest mark length 13 is defined by three special parameters, the pulse length T₃, the gap length T_{c3} and the shift of the leading edge dT₃.

The new high speed DVD+RW discs (3.3× to 8×) use a 2T write strategy, which is described in the “High speed DVD+ReWritable part 1 Single layer, volume 2:8x, volume2” from December 2004. Also for the new high speed DVD-RW discs (3.3× to 6×) a 2T write strategy is used, which is described in the “DVD specifications for Re-recordable disc (DVD-RW) Part 1, optional specification 6× speed DVD-RW revision 3.0” from September 2004.

The write strategy tuning for the new high speed DVD+RW (max 8×) and DVD-RW (max 6×) disc is very critical. It is very difficult to tune these discs to its optimum for jitter and Bler (bit length error rate), especially for high DOW (direct overwrite) cycles and archival overwrite (writing over old data after some time). The tuning is also speed depended, where the most difficult speed to optimize/tune the write strategy is 6×. The general performance obtained using the above called standard write strategies (i.e. for DVD+RW and DVD-RW strategies respectively) is rather low.

It is an object of the present invention to provide a recording apparatus and a corresponding recording method which enable a more simple tuning of the drive and lead to improved write performance on the discs.

The object is achieved according to the present invention by a recording apparatus as claimed in claim 1 comprising:

a radiation source for providing the radiation beam, and

a control unit for controlling the power of the radiation beam according to a data pulse representing the mark to be written, to provide said sequences of write pulses for recording the marks, said control unit being operative for setting the following parameters:

a trailing time (dT_{mplp,o}) of the last pulse of a sequence for writing a mark of length NT, in case N is an odd number, relative to the trailing edge of the last channel bit of the data pulse representing a shortest allowable mark, a trailing time (dT_{mplp,e}) of the last pulse of a sequence for writing a mark of length NT, in case N is an even number, relative to the trailing edge of the last channel bit of the data pulse, and

a lead time (dT_{lp,e}) of the last pulse of a sequence for writing a mark of length NT, in case N is an even number, relative to the leading edge of the last channel bit of the data pulse.

A corresponding recording method is defined in claim 8. A computer program for implementing the control steps of said method is defined in claim 9. Preferred embodiments of the invention are defined in the dependent claims.

The invention is based on the idea to define a new write strategy which combines the advantages of the known standard strategies by adapting the control unit such that it is able to use all parameters for tuning the write strategy, or, more particularly, the control signal which the power of the radiation beam is controlled. Thus, the major advantages of this new write strategy are that—compared to the known strategies—it is possible to use three extra tuning parameters. In particular, with this new write strategy it is possible to record DVD-RW discs at 6× and also at 3.3× based on the improved 2T write strategy instead of a 1T write strategy for 3.3×. This has major advantages for the firmware and the performance of the recording apparatus (e.g. a DVD-recorder) which does not need to store two or more different write strategies but only a single write strategy which can be used with different types of record carriers.

The invention thus can avoid the disadvantage of the write strategy according to the DVD-RW standard, by which the start time of the pulses cannot be tune. Further, the disadvantage of the write strategy according to the DVD+RW standard can be avoided by which the trailing time of the last pulse of the sequence for writing a mark (even and odd mark) relative to the leading edge of the last channel bit of the data pulse and the lead time of the last pulse of a sequence for writing a mark of length N, in case N is an even number relative to the leading edge of the last channel bit of the data pulse, cannot be tuned.

The new write strategy as defined in the embodiment of claim 2 combines the advantages of the 2T High speed DVD+RW and DVD-RW strategy definitions. It is thus possible to use three extra tuning parameters for high speed DVD+RW (3.3× to 8×) and to use 4 extra tuning parameters for high speed DVD-RW (3.3× to 6×). The new write strategy is also backwards compatible, which means that the standard definitions for high speed DVD-RW and high speed DVD+RW still can be used by the firmware in a DVD-recorder by simply setting the extra parameters that are not needed to zero.

In a preferred embodiment N represents an integer value in the range from 3 to 11, i.e. allowed marks lengths range from 3T to 11T. Further, in an embodiment it is preferred that the control unit is adapted for recording marks according to a 2T write strategy, wherein an even mark having a time length of NT, where n is representing an integer value equal to 4, 6, 8 or 10, is written by a sequence of N/2 write pulses,

an odd mark having a time length of NT, where N is representing an integer value equal to 5, 7, 9 or 11, is written by a sequence of (N−1)/2 write pulses, and

a mark having a time length of 3T is written by a single write pulse. Such 2T write strategies are generally known and described, for instance, in the above mentioned patent application.

To get the values for the parameters which are used by the control unit to tune the write strategy in a further embodiment a reading unit provided for reading values to be set for said parameters from said record carrier. However, the values can also be retrieved from another place, for instance, as proposed in another embodiment, from a storage memory for storing values to be set for said parameters for different types of record carriers. In this embodiment, an identification unit for identifying the type of record carrier to which data shall be recorded and a reading unit for reading values to be set for said parameters from said storage memory are provided in addition.

The method and apparatus according to the present invention are also backwards compatible. For instance, for use in DVD, the standard definitions for high speed DVD-RW and high speed DVD+RW still can be used by the firmware in a DVD-recorder by simply setting the extra parameters to zero that are not used by the respective standard to zero. Thus, in a preferred embodiment the control means are adapted to set one or more of said parameters to zero in case another write strategy shall be applied that does not use said parameters or in case no values can be obtained to which said parameters can be set.

The invention will now be explained in more detail with reference to the drawings in which

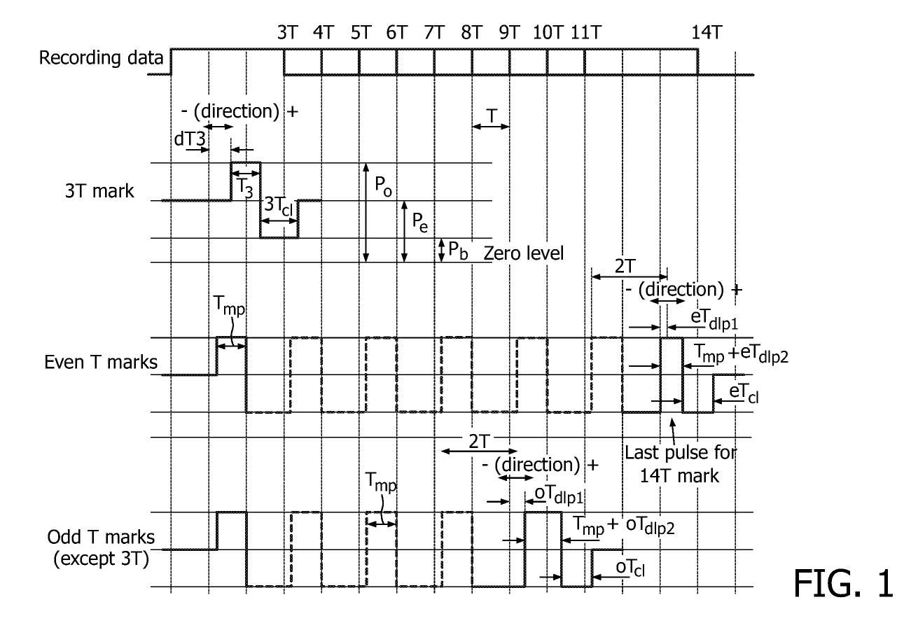

FIG. 1 shows diagrams of the time dependency of a digital data signal and of control signals for controlling the power of the radiation beam for recording marks according to the high-speed DVD-RW standard,

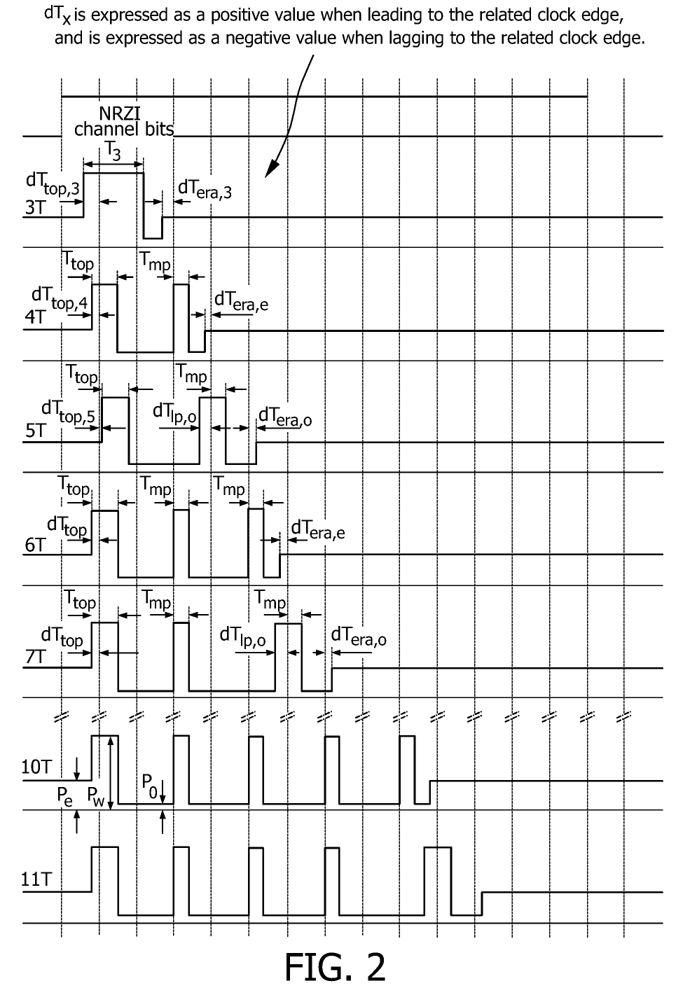

FIG. 2 shows diagrams of the time dependency of a digital data signal and of control signals for controlling the power of the radiation beam for recording marks according to the high-speed DVD+RW standard,

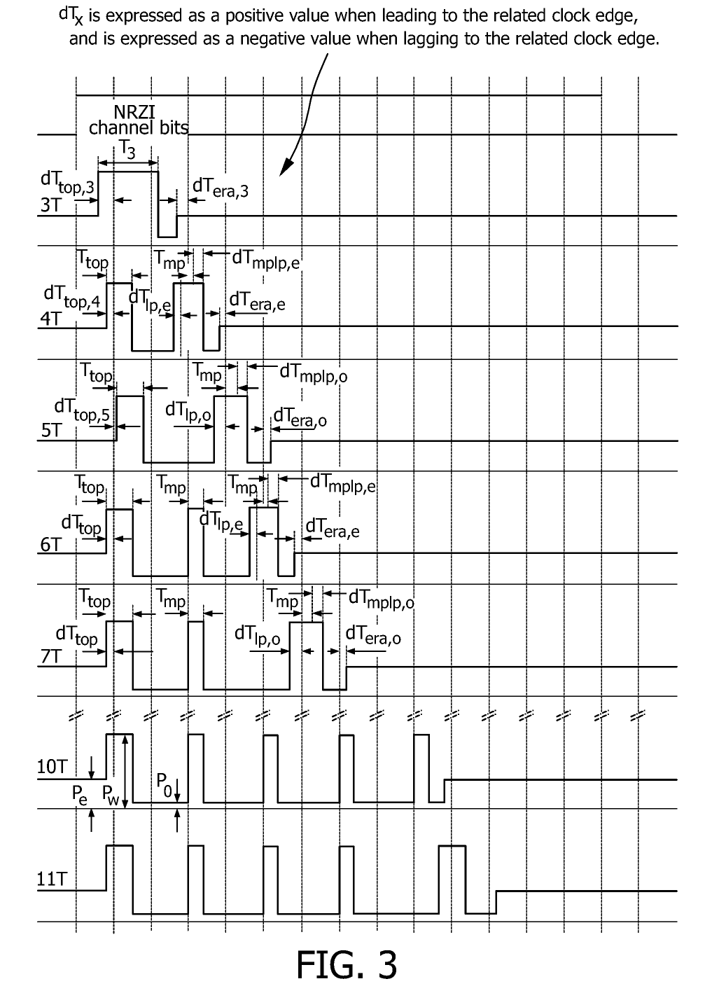

FIG. 3 shows diagrams of the time dependency of a digital data signal and of control signals for controlling the power of the radiation beam for recording marks according to the present invention, and

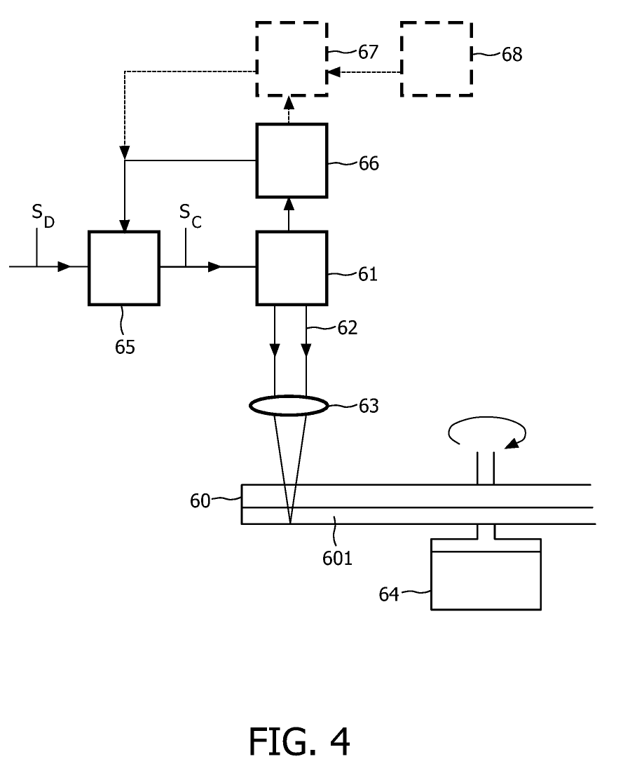

FIG. 4 shows a block diagram of a recording device according to the present invention.

FIG. 1 illustrates the write strategy definition of the high speed DVD-RW disc as mentioned in the “DVD specifications for Re-recordable disc (DVD-RW) Part 1, optional specification 6× speed DVD-RW revision 3.0” from September 2004.

FIG. 1a shows a digital data signal 100 as a function of time. The values of this digital data signal 100 represent the length of marks to be recorded in the information layer of a record carrier. The vertical dotted lines indicate transitions in a reference clock signal belonging to the data signal 100. One period of this reference clock, also called the channel bit period, is indicated by T. The digital data signal 100 represents marks to be recorded in the range from 3T to 11T, that is marks having a length substantially equal to the duration of 3 to 11 periods of the reference clock times the recording speed.

FIG. 1b schematically shows the a control signal 200 for recording a 3T mark. FIG. 1c schematically shows the corresponding control signals 201 for recording the even marks, that is the 4T, 6T, 8T and 10T marks, while FIG. 1d schematically shows the corresponding control signals 202 for recording the odd marks, that is the 5T, 7T, 9T and 11T marks.

The control signals are used to control the power of the radiation beam, where it is assumed that the power of the radiation beam is proportional to the corresponding level of the control signal. A mark is recorded by a sequence of pulses having a write power level Pₒ (generally also called P_{w}) and having a bias power level Pb (generally also called P_{c}) in between the pulses. Previously recorded marks between the marks being recorded are erased by applying an erase power level Pₑ.

FIG. 1b shows a control signal 200 for recording a 3T mark. The 3T mark is written by a single pulse the start of which is delayed by a period of dT₃ (dT₃ being negative in this case) relative to the start of write pulses for writing an even or odd mark and which is a period of Δ₃-dT₃ longer than the write pulses for writing an even mark. Further, for control signal 200 a parameter Θ₃ is defined as the beginning of the erase pulse level Pₑ relative to the nominal mark length, i.e. for the 3T mark the erase power level Pₑ starts (3-Θ₃)T after the beginning of the 3T mark.

Because a 2T write strategy is used, the even marks having a time length of nT are recorded by a sequence of n/2 pulses, and the odd marks having a time length of nT are recorded by a sequence of (n−1)/2 pulses. This results in a 4T even mark and a 5T odd mark being recorded by a sequence of 2 pulses, a 6T even mark and a 7T odd mark being recorded by a sequence of 3 pulses, a 8T even mark and a 9T odd mark being recorded by a sequence of 4 pulses and a 10T even mark and a 11T odd mark being recorded by a sequence of 5 pulses, as is indicated by the dashed lines in FIGS. 1c and 1d. A number of further parameters are defined according to the high-speed DVD-RW standard:

the pulse duration Tₘₚ of the second and higher pulses of a sequence (also called multi pulse duration for marks ≧4T),

a trailing time eT_{dlp2} of the last pulse of a sequence for writing a mark of length NT, in case N is an odd number, relative to the trailing edge of the last channel bit of the data pulse representing a shortest allowable mark (also called last pulse lag time for odd marks),

a trailing time oT_{dlp2} of the last pulse of a sequence for writing a mark of length NT, in case N is an even number, relative to the trailing edge of the last channel bit of the data pulse (also called last pulse lag time for even marks), and

the pulse duration T₃ of the first pulse of a sequence for writing a shortest mark,

a lead time dT₃ of the first pulse of a sequence relative to the trailing edge of the first channel bit of the data pulse representing a shortest allowable mark (also called pulse lead/lag time for 3T mark),

a lead time oT_{dTlp1} of the last pulse of a sequence for writing a mark of length NT, in case N is an odd number, relative to the leading edge of the last channel bit of the data pulse representing a shortest allowable mark (also called last pulse lead/lag time for odd marks),

a lead time eT_{dTlp1} of the last pulse of a sequence for writing a mark of length NT, in case N is an even number, relative to the leading edge of the last channel bit of the data pulse representing a shortest allowable mark (also called last pulse lead/lag time for even marks),

an erase lead time eT_{cl} of an erase pulse following a sequence for writing a mark of length NT, in case N is an even number, relative to the trailing edge of the last channel bit of the data pulse (also called erase pulse lead/lag time for even marks),

an erase lead time oT_{cl} of an erase pulse following a sequence for writing a mark of length NT, in case N is an odd number, relative to the trailing edge of the last channel bit of the data pulse (also called erase pulse lead/lag time for odd marks),

an erase lead time 3T_{cl} of an erase pulse following a sequence for writing a shortest allowable mark relative to the trailing edge of the last channel bit of the data pulse (also called erase pulse lead/lag time for 3T mark).

FIG. 2 illustrates the write strategy definition of the high speed DVD+RW disc as mentioned in the “High speed DVD+ReWritable part 1 Single layer, volume 2:8x, volume2” from December 2004. Similarly as in FIG. 1 a digital data signal 100 is shown in FIG. 2a, FIGS. 2b to 2h schematically show control signals 300 to 306 for recording a 3T, 4T, 5T, 6T, 7T, 10T and 11T mark. For recording a 8T and a 9T mark control signals similar as control signals 303 and 304, but with four pulses are used. The following parameters are defined according to the high-speed DVD+RW standard:

the pulse duration Tₜₒₚ of the first pulse of a sequence (also called first pulse duration for marks ≧4T),

the pulse duration Tₘₚ of the second and higher pulses of a sequence (also called multi pulse duration for marks ≧4T),

the pulse duration T₃ of the first pulse of a sequence for writing a shortest mark,

a lead time dT₃ of the first pulse of a sequence relative to the trailing edge of the first channel bit of the data pulse representing a shortest allowable mark (also called pulse lead/lag time for 3T mark),

a lead time dT₄ of the first pulse of a sequence relative to the trailing edge of the first channel bit of the data pulse representing a second shortest allowable mark (also called first pulse lead/lag time for 4T mark),

a lead time dT₅ of the first pulse of a sequence relative to the trailing edge of the first channel bit of the data pulse representing a third shortest allowable mark (also called first pulse lead/lag time for 5T mark),

a lead time dT_{lp,o} of the last pulse of a sequence for writing a mark of length NT, in case N is an odd number, relative to the leading edge of the last channel bit of the data pulse representing a shortest allowable mark (also called last pulse lead/lag time for odd marks),

an erase lead time dT_{era,e} of an erase pulse following a sequence for writing a mark of length NT, in case N is an even number, relative to the trailing edge of the last channel bit of the data pulse (also called erase pulse lead/lag time for even marks),

an erase lead time dT_{era,o} of an erase pulse following a sequence for writing a mark of length NT, in case N is an odd number, relative to the trailing edge of the last channel bit of the data pulse (also called erase pulse lead/lag time for odd marks),

an erase lead time dT_{era,3} of an erase pulse following a sequence for writing a shortest allowable mark relative to the trailing edge of the last channel bit of the data pulse (also called erase pulse lead/lag time for 3T mark), and

a lead time dTₜₒₚ of the first pulse of a sequence relative to the trailing edge of the first channel bit of the data pulse (also called first pulse lead/lag time for marks ≧6T).

FIG. 3 illustrates the proposed write strategy definition, in the example shown as a 2T write strategy for high speed DVD+/−RW. Similarly as in FIGS. 1 and 2 a digital data signal 100 is shown in FIG. 3a, FIGS. 3b to 3h schematically show control signals 400 to 406 for recording a 3T, 4T, 5T, 6T, 7T, 10T and 11T mark. For recording a 8T and a 9T mark control signals similar as control signals 403 and 404, but with four pulses are used. Compared to the parameters defined according to the DVD+RW standard as explained above with reference to FIG. 2, the following parameters additional parameters are defined according to the present invention:

a trailing time dT_{mplp,o} of the last pulse of a sequence for writing a mark of length NT, in case N is an odd number, relative to the trailing edge of the last channel bit of the data pulse representing a shortest allowable mark (also called last pulse lag time for odd marks),

a trailing time dT_{mplp,e} of the last pulse of a sequence for writing a mark of length NT, in case N is an even number, relative to the trailing edge of the last channel bit of the data pulse (also called last pulse lag time for even marks), and

a lead time dT_{lp,e} of the last pulse of a sequence for writing a mark of length NT, in case N is an even number, relative to the leading edge of the last channel bit of the data pulse (also called last pulse lead time for even marks.

All the write strategy parameters for the different standards are shown in the table below.

Write Strategy Parameters

| No # | DVD+RW | DVD−RW | New DVD+/−RW |
|---|---|---|---|
| 1 | Tₜₒₚ | — | Tₜₒₚ |
| 2 | Tₘₚ | Tₘₚ | Tₘₚ |
| 3 | — | eT_{dlp2} | dT_{mplp,o} |
| 4 | — | oT_{dlp2} | dT_{mplp,e} |
| 5 | T₃ | T₃ | T₃ |
| 6 | dT₃ | dT₃ | dT₃ |
| 7 | dT₄ | — | dT₄ |
| 8 | dT₅ | — | dT₅ |
| 9 | dT_{lp,o} | oT_{dTlp1} | dT_{lp,o} |
| 10 | — | eT_{dTlp1} | dT_{lp,e} |
| 11 | dT_{era,e} | ET_{cl} | dT_{era,e} |
| 12 | dT_{era,o} | OT_{cl} | dT_{era,o} |
| 13 | dT_{era,3} | 3T_{cl} | dT_{era,3} |
| 14 | dTₜₒₚ | — | dTₜₒₚ |

This table also shows the backwards compatibility of the proposed new write strategy. According to the invention the advantages of the DVD+RW and DVD-RW write strategy definitions are combined. Basically, the parameters dT_{mplp,o}, dT_{mplp,e} and dT_{lp,e} parameters are added to the DVD+RW strategy. By using the parameters dT_{mplp,o}, dT_{mplp,e} it is possible to adjust the width of the last pulse of the 4T, 5T, 6T, even and odd marks. The parameter dT_{lp,e} can be used to adjust the start position of the last pulse for 4T and even marks.

FIG. 4 shows an embodiment of the recording device according to the present invention for recording marks in an information layer 601 of a disc-shaped record carrier 60. The information layer 601 is of the so-called phase-change type, that is, it has a phase reversibly changeable between a crystal phase and an amorphous phase. The record carrier is rotated around its centre by a motor 64. A radiation beam 62 is generated by a radiation source 61, such as for example a laser light source, and focussed onto the information layer 601 by a lens 63.

The power of the radiation beam 62 is controlled by a control signal S_{C} provided by a control unit 65, where it is assumed that the power of the radiation beam 62 is proportional to the corresponding level of the control signal S_{C}. Examples of such a control signal S_{C} as proposed according to the present invention have been shown in FIGS. 3a to 3d. The control unit 65 converts a digital data signal SD representing the length of a mark to be recorded in the information 601 of the record carrier 60 into a corresponding control signal S_{C}. This conversion is based on a so-called write strategy, which is a 2T write strategy according to the present invention. Examples of such digital data signals SD are shown in FIG. 3a (data signal 100).

In the embodiment of the recording device shown in FIG. 4 a reading unit 66 is provided for reading values to be set for the parameters to be used in the proposed new write strategy from the record carrier 60, i.e. the record carrier stores in a certain place values to be used by a recording device when it wants to record information thereon. These parameters are input to the control unit 65 where this values are set and where the corresponding control signal is generated.

In an alternative embodiment, indicated by dashed lines, a storage memory 67 for storing values to be set for said parameters for different types of record carriers and an identification unit 68 for identifying the type of record carrier to which data shall be recorded are provided. The reading unit 66 then can reads the values to be set for the parameters used in the proposed new write strategy from said storage memory 67, in particular if no values are stored on the record carrier 60 itself.

If, instead of the new write strategy, a known write strategy shall be used. In a known recording device (i.e. a known drive) there is provided a lookup table were the write strategy for a couple of disc brands, i.e. known discs, are stored. Among them lookup tables for all types of discs (e.g. low and high speed DVD+/−RW, CD-RW, DVD+R, DVD Dual Layer discs) are provided. When an “unknown” disc (which is not inserted in the lookup table of the drive) is inserted into the drive, then the write strategy is taken from the disc itself (ATIP or ADIP info) and that write strategy will be used according to the known write strategy standards. For example, if an “unknown” 8×DVD+RW disc is inserted the write strategy will be according to the “High speed DVD+ReWritable part 1 Single layer, volume 2:8x, volume2” standards book. The extra parameters which are proposed for use according to the present invention will then be set to zero by the firmware, i.e. these parameters are not used in this case. Thus, according to the present invention, the control unit 65 can, also in this case, apply the new write strategy, but sets the values for parameters that are not used in the write strategy to be applied to zero.

The proposed new write strategy can be applied in the new DVD recorders which support high speed DVD+RW and DVD-RW (≧3× to 8×) discs. The advantages from both strategies can thus be combined without requiring to store both write strategies in the firmware of the recording device. However, the present invention is generally not limited to the application in DVD, but can be applied to any write strategy which uses the parameter as defined in claim 1 to achieve high DOW performance and high archival overwrite performance.

1. Recording apparatus for recording marks in an information layer (601) of a record carrier (60) by irradiating the information layer by means of a radiation beam, said information layer having a phase reversibly changeable between a first phase and a second phase, wherein a mark is written by a sequence of one or more write pulses, the number of write pulses of the sequence for writing a mark of length NT, T being the length of a reference clock, being determined by application of a predetermined write strategy, comprising:
a radiation source (61) for providing the radiation beam (62), and
a control unit (65) for controlling the power of the radiation beam according to a data pulse representing the mark to be written, to provide said sequences of write pulses for recording the marks, said control unit being operative for setting the following parameters:
a trailing time (dT_{mplp,o}) of the last pulse of a sequence for writing a mark of length NT, in case N is an odd number, relative to the trailing edge of the last channel bit of the data pulse representing a shortest allowable mark,
a trailing time (dT_{mplp,e}) of the last pulse of a sequence for writing a mark of length NT, in case N is an even number, relative to the trailing edge of the last channel bit of the data pulse, and
a lead time (dT_{lp,e}) of the last pulse of a sequence for writing a mark of length NT, in case N is an even number, relative to the leading edge of the last channel bit of the data pulse.

2. Recording apparatus as claimed in claim 1, wherein the control unit (65) is further operative for setting one or more of the following parameters:
the pulse duration (Tₜₒₚ) of the first pulse of a sequence,
the pulse duration (Tₘₚ) of the second and higher pulses of a sequence,
the pulse duration (T₃) of the first pulse of a sequence for writing a shortest mark,
a lead time (dT₃) of the first pulse of a sequence relative to the trailing edge of the first channel bit of the data pulse representing a shortest allowable mark,
a lead time (dT₄) of the first pulse of a sequence relative to the trailing edge of the first channel bit of the data pulse representing a second shortest allowable mark,
a lead time (dT₅) of the first pulse of a sequence relative to the trailing edge of the first channel bit of the data pulse representing a third shortest allowable mark,
a lead time (dT_{lp,o}) of the last pulse of a sequence for writing a mark of length NT, in case N is an odd number, relative to the leading edge of the last channel bit of the data pulse representing a shortest allowable mark,
an erase lead time (dT_{era,e}) of an erase pulse following a sequence for writing a mark of length NT, in case N is an even number, relative to the trailing edge of the last channel bit of the data pulse,
an erase lead time (dT_{era,o}) of an erase pulse following a sequence for writing a mark of length NT, in case N is an odd number, relative to the trailing edge of the last channel bit of the data pulse,
an erase lead time (dT_{era,3}) of an erase pulse following a sequence for writing a shortest allowable mark relative to the trailing edge of the last channel bit of the data pulse, and
a lead time (dTₜₒₚ) of the first pulse of a sequence relative to the trailing edge of the first channel bit of the data pulse.

3. Recording apparatus as claimed in claim 1, wherein N represents an integer value in the range from 3 to 11.

4. Recording apparatus as claimed in claim 3, wherein the control unit (65) is adapted for recording marks according to a 2T write strategy, wherein an even mark having a time length of NT, where n is representing an integer value equal to 4, 6, 8 or 10, is written by a sequence of N/2 write pulses,
an odd mark having a time length of NT, where N is representing an integer value equal to 5, 7, 9 or 11, is written by a sequence of (N−1)/2 write pulses, and
a mark having a time length of 3T is written by a single write pulse.

5. Recording apparatus as claimed in claim 1, further comprising a reading unit (66) for reading values to be set for said parameters from said record carrier.

6. Recording apparatus as claimed in claim 1, further comprising
a storage memory (67) for storing values to be set for said parameters for different types of record carriers,
an identification unit (68) for identifying the type of record carrier to which data shall be recorded and
a reading unit (66) for reading values to be set for said parameters from said storage memory.

7. Recording apparatus as claimed in claim 1, wherein said control unit (65) is adapted to set one or more of said parameters to zero in case another write strategy shall be applied that does not use said parameters or in case no values can be obtained to which said parameters can be set.

8. Recording method for recording marks in an information layer (601) of a record carrier (60) by irradiating the information layer by means of a radiation beam (62), said information layer having a phase reversibly changeable between a first phase and a second phase, wherein a mark is written by a sequence of one or more write pulses, the number of write pulses of the sequence for writing a mark of length NT, T being the length of a reference clock, being determined by application of a predetermined write strategy, comprising the steps of:
providing the radiation beam, and controlling the power of the radiation beam according to a data pulse representing the mark to be written, to provide said sequences of write pulses for recording the marks, where the following parameters are set:
a trailing time (dT_{mplp,o}) of the last pulse of a sequence for writing a mark of length NT, in case N is an odd number, relative to the trailing edge of the last channel bit of the data pulse representing a shortest allowable mark,
a trailing time (dT_{mplp,e}) of the last pulse of a sequence for writing a mark of length NT, in case N is an even number, relative to the trailing edge of the last channel bit of the data pulse, and
a lead time (dT_{lp,e}) of the last pulse of a sequence for writing a mark of length NT, in case N is an even number, relative to the leading edge of the last channel bit of the data pulse.

9. Computer program comprising program code means for causing a computer to carry out the control steps of the method as claimed in claim 8 when said computer program is carried out on a computer.
